(19) United States
(12) Patent Application Publication
(10) Pub. No.: US 2003/0169219 A1
(43) Pub. Date: Sep. 11, 2003

(54) System and method for exposure timing compensation for row resistance

(76) Inventor: Robert LeChevalier, Golden, CO (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/274,491

(22) Filed: Oct. 17, 2002

Related U.S. Application Data
(60) Provisional application No. 60/342,637, filed on Oct. 19, 2001.
(60) Provisional application No. 60/343,856, filed on Oct. 19, 2001.
(60) Provisional application No. 60/343,638, filed on Oct. 19, 2001.
(60) Provisional application No. 60/342,582, filed on Oct. 19, 2001.
(60) Provisional application No. 60/346,102, filed on Oct. 19, 2001.
(60) Provisional application No. 60/353,753, filed on Oct. 19, 2001.
(60) Provisional application No. 60/342,793, filed on Oct. 19, 2001.
(60) Provisional application No. 60/342,791, filed on Oct. 19, 2001.
(60) Provisional application No. 60/343,370, filed on Oct. 19, 2001.
(60) Provisional application No. 60/342,783, filed on Oct. 19, 2001.
(60) Provisional application No. 60/342,794, filed on Oct. 19, 2001.

(51) Int. Cl. G09G 3/34

(52) U.S. Cl. 345/84

(57) ABSTRACT

A current driving circuit for use with a display of light emitting elements arranged in rows and columns. The current driving circuit is configured to control the exposure time of column current sources based on the row voltage seen by the pixel in that column. The current driving circuit allows for more closely matching the currents across the array of light emitting elements in the display by compensating for variations in voltage caused by resistance in the row lines. The invention also provides a method of balancing currents in a display device comprising controlling the exposure time of column current sources based on the row voltage seen by the light emitting elements in the column.

### RELATED APPLICATIONS

This application claims priority to, and hereby incorporates by reference, the following patent applications:

U.S. Provisional Patent Application No. 60/342,637, filed on Oct. 19, 2001, entitled PROPORTIONAL PLUS INTEGRAL LOOP COMPENSATION USING A HYBRID OF SWITCHED CAPACITOR AND LINEAR AMPLIFIERS (Attorney Docket No. CLMCR.009PR);

U.S. Provisional Patent Application No. 60/343,856, filed on Oct. 19, 2001, entitled CHARGE PUMP ACTIVE GATE DRIVE (Attorney Docket No. CLMCR.010PR);

U.S. Provisional Patent Application No. 60/343,638, filed on Oct. 19, 2001, entitled CLAMPING METHOD AND APPARATUS FOR SECURING A MINIMUM REFERENCE VOLTAGE IN A VIDEO DISPLAY BOOST REGULATOR (Attorney Docket No. CLMCR.011PR);

U.S. Provisional Patent Application No. 60/342,582, filed on Oct. 19, 2001, entitled PRECHARGE VOLTAGE ADJUSTING METHOD AND APPARATUS (Attorney Docket No. CLMCR.013PR);

U.S. Provisional Patent Application No. 60/346,102, filed on Oct. 19, 2001, entitled EXPOSURE TIMING COMPENSATION FOR ROW RESISTANCE (Attorney Docket No. CLMCR.014PR);

U.S. Provisional Patent Application No. 60/353,753, filed on Oct. 19, 2001 entitled METHOD AND SYSTEM FOR PRECHARGING OLED/PLED DISPLAYS WITH A PRECHARGE SWITCH LATENCY (Attorney Docket No. CLMCR.015PR);

U.S. Provisional Patent Application No. 60/342,793, filed on Oct. 19, 2001, entitled ADAPTIVE CONTROL BOOST CURRENT METHOD AND APPARATUS, filed on Oct. 19, 2001 (Attorney Docket No. CLMCR.017PR);

U.S. Provisional Patent Application No. 60/342,791, filed on Oct. 19, 2001, entitled PREDICTIVE CONTROL BOOST CURRENT METHOD AND APPARATUS (Attorney Docket No. CLMCR.018PR);

U.S. Provisional Patent Application No. 60/343,370, filed on Oct. 19, 2001, entitled RAMP CONTROL BOOST CURRENT METHOD AND APPARATUS (Attorney Docket No. CLMCR.019PR);

U.S. Provisional Patent Application No. 60/342,783, filed on Oct. 19, 2001, entitled ADJUSTING PRECHARGE FOR CONSISTENT EXPOSURE VOLTAGE (Attorney Docket No. CLMCR.020PR); and

U.S. Provisional Patent Application No. 60/342,794, filed on Oct. 19, 2001, entitled PRECHARGE VOLTAGE CONTROL VIA EXPOSURE VOLTAGE RAMP (Attorney Docket No. CLMCR.021PR);

This application is related to, and hereby incorporates by reference, the following patent applications:

U.S. Provisional Application No. 60/290,100, filed May 9, 2001, entitled “METHOD AND SYSTEM FOR CURRENT BALANCING IN VISUAL DISPLAY DEVICES”, (Attorney Docket No. CLMCR.004PR);

U.S. patent application entitled “CURRENT BALANCING CIRCUIT”, filed May 7, 2002 (Attorney Docket No. CLMCR.004A);

U.S. patent application entitled “CURRENT BALANCING CIRCUIT”, filed May 7, 2002 (Attorney Docket No. CLMCR.004A1);

U.S. patent application Ser. No. 09/904,960, filed Jul. 13, 2001, entitled “BRIGHTNESS CONTROL OF DISPLAYS USING EXPONENTIAL CURRENT SOURCE” (Attorney Docket No. CLMCR.005A);

U.S. patent application Ser. No. 10/141659, filed on May 7, 2002, entitled “MATCHING SCHEME FOR CURRENT CONTROL IN SEPARATE I.C.S.” (Attorney Docket No. CLMCR.006A);

U.S. patent application Ser. No. 10/141326, filed May 7, 2002, entitled “MATCHING SCHEME FOR CURRENT CONTROL IN SEPARATE I.C.S.” (Attorney Docket No. CLMCR.006A1);

U.S. patent application Ser. No. 09/852,060, filed May 9, 2001, entitled “MATRIX ELEMENT VOLTAGE SENSING FOR PRECHARGE” (Attorney Docket No. CLMCR.008A);

U.S. patent application entitled “METHOD AND SYSTEM FOR PROPORTIONAL AND INTEGRAL LOOP COMPENSATION USING A HYBRID OF SWITCHED CAPACITOR AND LINEAR AMPLIFIERS”, filed on even date herewith (Attorney Docket No. CLMCR.009A);

U.S. patent application entitled “METHOD AND SYSTEM FOR CHARGE PUMP ACTIVE GATE DRIVE”, filed on even date herewith (Attorney Docket No. CLMCR.010A);

U.S. patent application entitled “METHOD AND CLAMPING APPARATUS FOR SECURING A MINIMUM REFERENCE VOLTAGE IN A VIDEO DISPLAY BOOST REGULATOR”, filed on even date herewith (Attorney Docket No. CLMCR.011A);

U.S. patent application Ser. No. 10/141,648, filed May 7, 2002, entitled “APPARATUS FOR PERIODIC ELEMENT VOLTAGE SENSING TO CONTROL PRECHARGE” (Attorney Docket No. CLMCR.012A);

U.S. patent application Ser. No. 10/141,318, filed May 7, 2002, entitled “METHOD FOR PERIODIC ELEMENT VOLTAGE SENSING TO CONTROL PRECHARGE,” (Attorney Docket No. CLMCR.012A1);

U.S. patent application entitled “MATRIX ELEMENT PRECHARGE VOLTAGE ADJUSTING APPARATUS AND METHOD”, filed on even date herewith (Attorney Docket No. CLMCR.013A);

U.S. patent application entitled “METHOD AND SYSTEM FOR PRECHARGING OLED/PLED DISPLAYS WITH A PRECHARGE LATENCY”, filed on even date herewith (Attorney Docket No. CLMCR.015A);

U.S. Provisional Application No. 60/348,168 filed Oct. 19, 2001, entitled “PULSE AMPLITUDE MODULATION SCHEME FOR OLED DISPLAY DRIVER”, filed on even date herewith (Attorney Docket No. CLMCR.016PR);

U.S. patent application Ser. No. 10/029563, filed Dec. 20, 2001, entitled “METHOD OF PROVIDING PULSE AMPLITUDE MODULATION FOR OLED DISPLAY DRIVERS” (Attorney Docket No. CLMCR.016A);

U.S. patent application Ser. No. 10/029605, filed Dec. 20, 2001, entitled “SYSTEM FOR PROVIDING PULSE AMPLITUDE MODULATION FOR OLED DISPLAY DRIVERS” (Attorney Docket No. CLMCR.016A1);

U.S. patent application entitled “ADAPTIVE CONTROL BOOST CURRENT METHOD AND APPARATUS”, filed on even date herewith (Attorney Docket No. CLMCR.017A);

U.S. patent application entitled “PREDICTIVE CONTROL BOOST CURRENT METHOD AND APPARATUS”, filed on even date herewith (Attorney Docket No. CLMCR.018A);

U.S. patent application entitled “RAMP CONTROL BOOST CURRENT METHOD”, filed on even date herewith (Attorney Docket No. CLMCR.019A);

U.S. patent application entitled “METHOD AND SYSTEM FOR ADJUSTING PRECHARGE FOR CONSISTENT EXPOSURE VOLTAGE”, filed on even date herewith (Attorney Docket No. CLMCR.020A);

U.S. patent application entitled “METHOD AND SYSTEM FOR RAMP CONTROL OF PRECHARGE VOLTAGE”, filed on even date herewith (Attorney Docket No. CLMCR.021A).

### BACKGROUND OF THE INVENTION

1. Field of the Invention

This invention generally relates to electrical drivers for a matrix of current driven devices, and more particularly to methods and apparatus for determining and providing a precharge for such devices.

2. Description of the Related Art

There is a great deal of interest in “flat panel” displays, particularly for small to midsized displays, such as may be used in laptop computers, cell phones, and personal digital assistants. Liquid crystal displays (LCDs) are a well-known example of such flat panel video displays, and employ a matrix of “pixels” which selectably block or transmit light. LCDs do not provide their own light; rather, the light is provided from an independent source. Moreover, LCDs are operated by an applied voltage, rather than by current. Luminescent displays are an alternative to LCD displays. Luminescent displays produce their own light, and hence do not require an independent light source. They typically include a matrix of elements which luminesce when excited by current flow. A common luminescent device for such displays is a light emitting diode (LED).

LED arrays produce their own light in response to current flowing through the individual elements of the array. The current flow may be induced by either a voltage source or a current source. A variety of different LED-like luminescent sources have been used for such displays. As used herein, organic electroluminescent OLEDs (organic light emitting diodes), include polymer OLEDs (PLEDs) and small-molecule OLEDs, each of which is distinguished by their color, the molecular structure of the light producing material, as well as by their manufacturing processes. Electrically, these devices look like diodes with forward “on” voltage drops ranging from 2 volts (V) to 20 V depending on the type of OLED material used, the OLED aging, the magnitude of current flowing through the device, temperature, and other parameters. Unlike LCDs, OLEDs are current driven devices; however, they may be similarly arranged in a 2 dimensional array (matrix) of elements arranged in columns and rows to form a display. Therefore, the matrix contains current sources and column and row lines configured to drive current through the OLEDs in the display.

To improve the display response, it is desirable to initiate a precharge cycle to force an initial voltage onto column lines connecting the OLEDs prior to activation of the current source. The precharge immediately forces the OLEDs to peak luminescence at the voltage level they would have if the column lines were given sufficient time to stabilize in the absence of precharge. Display capacitance makes precharge a voltage driven operation that ideally brings all column lines to the same voltage. In reality, although the row lines can be made of low-resistive materials, finite row resistance causes voltage drops across row lines of the display. These voltage drops can cause undesirable luminosity variations across the columns of the display.

It may be appreciated that there is a need for a method and apparatus for compensating for luminosity variations due to inherent row resistances.

### SUMMARY OF THE INVENTION

In one embodiment, the invention provides an apparatus for driving current through a pixel of a display device having a display portion having a plurality of pixels arranged in columns. The apparatus includes a current source configured to generate a current across a pixel in one of the plurality of columns. The apparatus also comprises an exposure counter for generating counter values, an exposure data register and a memory for storing a look-up table, wherein said look up table contains values relating to an ideal exposure time of the pixel and values relating to a correction time for the exposure time of the pixel. The memory is connected to the exposure data register and is configured to send a compensating exposure time for the pixel of the display portion to the exposure data register. The apparatus further comprises a comparator configured to compare the compensating exposure value in the exposure data register and the counter values. The comparator generates a signal when the counter value matches the compensating exposure value, and wherein the signal causes the current source to stop generating the current.

In another embodiment, the invention includes a method of controlling the exposure of a pixel generated by a current source in a display having a plurality of pixels arranged in columns and rows. The method includes generating an ideal exposure time value for the pixel. The method also includes generating a correcting time value for the pixel that accounts for row-line resistance in the display. The method further includes generating a compensating exposure time value by combining the ideal exposure time and the corrected time. The method then includes the steps of comparing the compensating exposure time value with a counter value, and generating a signal to turn off the current source when the compensating exposure time value matches the counter value.

In another embodiment, the invention includes a method of generating a look-up table to be used by an apparatus for driving currents through a pixel of a display device having a display portion having a plurality of pixels arranged in a plurality of columns and rows. The method includes measuring the resistance in a row between the plurality of columns. The method further includes determining the total charge flowing into the pixel for each of a plurality of sub-intervals, summing the currents in each sub-interval is multiplied by the length of a subinterval and determining a voltage drop across the row from the exposure drive current and the resistance in the row. The method also includes averaging the exposure times to obtain an effective average row voltage drop, converting the average row voltage drop into a charge error for the plurality of with a table and converting the charge error to an exposure compensating time. The method the includes combining the exposure compensating time with an exposure time to obtain a compensated exposure time

Embodiments of the present invention incorporate may incorporate various combinations of the aspects explained above in order to promote speed and accuracy while efficiently driving a matrix of luminescent elements.

### BRIEF DESCRIPTION OF THE DRAWINGS

FIG. 1A is a simplified perspective view of an OLED display.

FIG. 1B is a cross-sectional view of the OLED display of FIG. 1A.

FIG. 2 is a simplified schematic diagram of a display, column driver cell and row driver cell for use with the OLED display of FIG. 1A.

FIG. 3 is a current-voltage curve for a typical OLED used in the display of FIG. 3.

FIG. 4 is a simplified schematic diagram of the column driver cell of FIG. 2.

FIG. 5 is a flow chart illustrating a method of compensating exposure timing according to an embodiment of the invention.

FIG. 6 is a flow chart illustrating the steps to create a look-up table for compensating exposure data according to an embodiment of the invention.

### DETAILED DESCRIPTION OF THE INVENTION

The aspects, features and advantages of the invention will be better understood by referring to the following detailed description in conjunction with the accompanying drawings. These drawings and the associated description are provided to illustrate embodiments of the invention, and not to limit the scope of the invention. The embodiments described below overcome obstacles to the accurate generation of a desired amount of light output from an LED display.

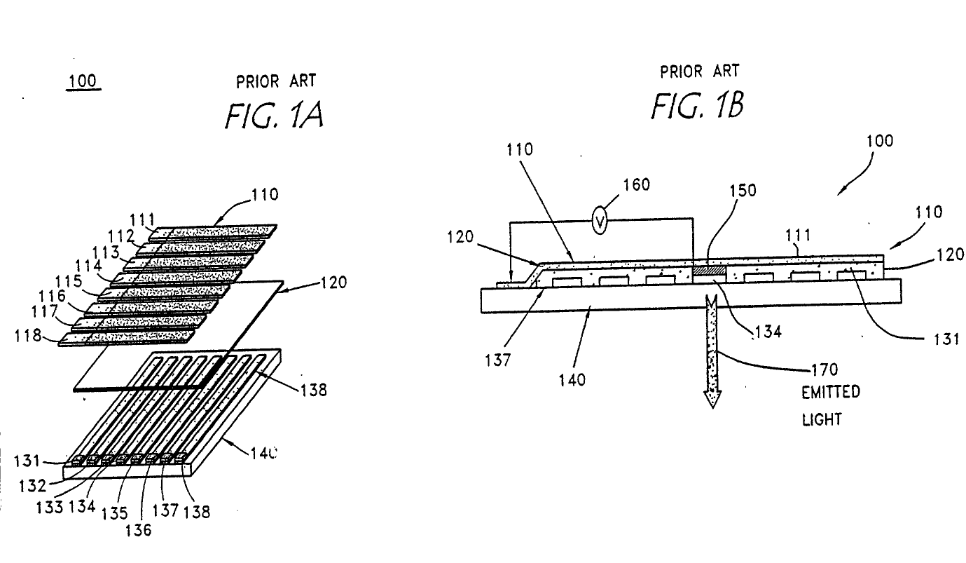

FIG. 1A is an exploded view of a typical physical structure of such a passive-matrix display 100 of OLEDs. A layer 110 having a representative series of rows, such as parallel conductors 111-118, is disposed on one side of a sheet of light emitting polymer, or other emissive material, 120. A representative series of columns are shown as parallel transparent conductors 131-138, which are disposed on the other side of sheet 120, adjacent to a glass plate 140. FIG. 1B is a cross-section of the display 100, and shows a drive voltage V applied between a row 111 and a column 134. A portion of the sheet 120 disposed between the row 111 and the column 134 forms an element 150 which behaves like an LED. The potential developed across this LED causes current flow, so the LED emits light 170. Since the emitted light 170 must pass through the column conductor 134, such column conductors are transparent. Most such transparent conductors have relatively high resistance compared with the row conductors 111-118, which may be formed from opaque materials, such as copper, having a low resistivity.

This structure results in a matrix of devices, one device formed at each point where a row overlies a column. There will generally be M×N devices in a matrix having M rows and N columns. Typical devices function like light emitting diodes (LEDs), which conduct current and luminesce when voltage of one polarity is imposed across them, and block current when voltage of the opposite polarity is applied. Exactly one device is common to both a particular row and a particular column, so to control these individual LED devices located at the matrix junctions it is useful to have two distinct driver circuits, one to drive the columns and one to drive the rows. It is conventional to sequentially scan the rows (conventionally connected to device cathodes) with a driver switch to a known voltage such as ground, and to provide another driver, which may be a current source, to drive the columns (which are conventionally connected to device anodes).

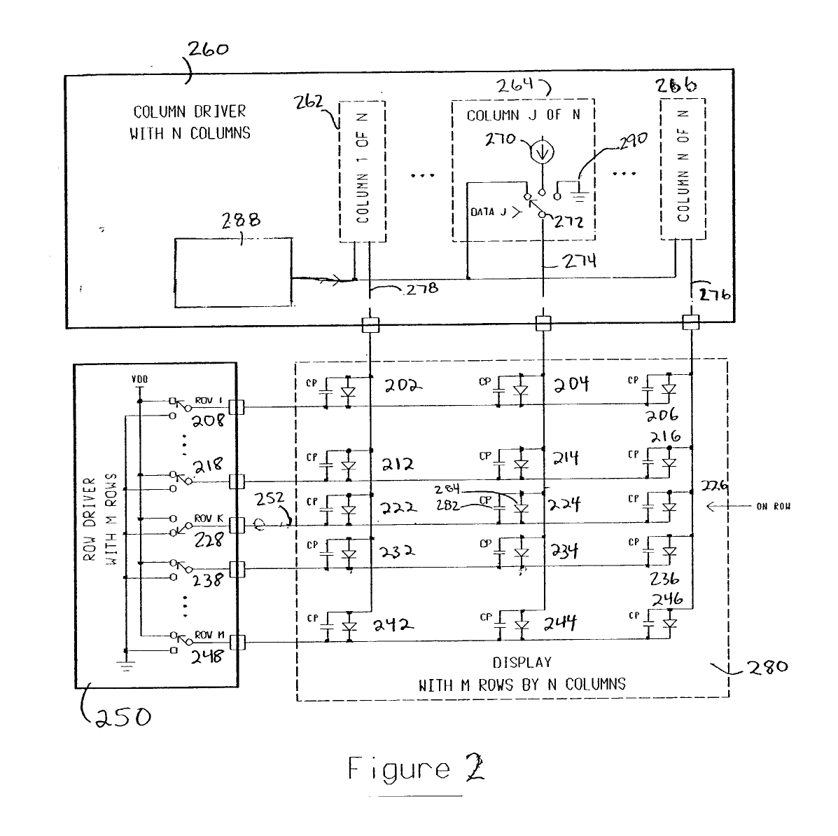

FIG. 2 is an embodiment of an arrangement for driving a display having M rows and N columns. A column driver device 260 includes one column drive circuit (e.g. 262, 264, 266) for each column. The column driver circuit 264 shows some of the details which are typically provided in each column driver, including a current source 270 and a switch 272 which enables a column connection 274 to be connected to either the current source 270 to illuminate the selected diode, or to ground to turn off the selected diode. A scan circuit 250 includes representations of row driver switches (208, 218, 228, 238 and 248). A luminescent display 280 represents a display having M rows and N columns, though only five representative rows and three representative columns are drawn.

The rows of FIG. 2 are typically a series of parallel connection lines traversing the back of a polymer, organic or other luminescent sheet, and the columns are a second series of connection lines perpendicular to the rows and traversing the front of such sheet, as shown in FIG. 1A. Luminescent elements are established at each region where a row and a column overlie each other so as to form connections on either side of the element. FIG. 2 represents each element as including both an LED aspect (indicated by a diode schematic symbol) and a parasitic capacitor aspect (indicated by a capacitor symbol labeled “CP”).

In operation, information is transferred to the matrix display by scanning each row in sequence. During each row scan period, each column connected to an element intended to emit light is also driven. For example, in FIG. 2 a row switch 228 grounds the row to which the cathodes of elements 222, 224 and 226 are connected during a scan of Row K. The column driver switch 272 connects the column connection 274 to the current source 270, such that the element 224 is provided with current. Each of the other columns 1 to N may also be providing current to the respective elements connected to Row K at this time, such as the elements 222 or 226. All current sources are typically at the same amplitude. OLED element light output is controlled by controlling the amount of time the current source for the particular column is on. When an OLED element has completed outputting light, its anode is pulled to ground to turn off the element. At the end of the scan period for Row K, the row switch 228 will typically disconnect Row K from ground and apply Vdd instead. Then, the scan of the next row will begin, with row switch 238 connecting the row to ground, and the appropriate column drivers supplying current to the desired elements, e.g. 232, 234 and/or 236.

Only one element (e.g. element 224) of a particular column (e.g. column J) is connected to each row (e.g. Row K), and hence only that element of the column is connected to both the particular column drive (264) and row drive (228) so as to conduct current and luminesce (or be “exposed”) during the scan of that row. However, each of the other devices on that particular column (e.g. elements 204, 214, 234 and 244 as shown, but typically including many other devices) are connected by the driver for their respective row (208, 218, 238 and 248 respectively) to a voltage source, Vdd. Therefore, the parasitic capacitance of each of the devices of the column is effectively in parallel with, or added to, the capacitance of the element being driven. The combined parasitic capacitance of the column limits the slew rate of a current drive such as drive 270 of column J. Nonetheless, rapid driving of the elements is necessary. All rows must be scanned many times per second to obtain a reasonable visual appearance, which permits very little time for conduction for each row. Low slew rates may cause large exposure errors for short exposure periods. Thus, for practical implementations of display drivers using the prior art scheme, the parasitic capacitance of the columns may be a severe limitation on drive accuracy.

Current sources such as the current source 270 are typically used to drive a predetermined current through a selected pixel element such as the element 224. However, the applied current will not flow through an OLED element until the parasitic capacitance is first charged. When the row switch 228 is connected to ground to scan Row K, the entire column connection 274 must reach a requisite voltage in order to drive the desired current in element 224. That voltage may be, for example, about 6V, and is a value which varies as a function of current, temperature, and time.

The voltage on the column connection 274 will move from a starting value toward a steady-state value, but not faster than the current source 270 can charge the combined capacitance of all of the parasitic capacitances of the elements connected to the column connection 274. In one display, for example, there may be 96 rows, and thus 96 devices connected to each column 274.

Each device may have a typical parasitic capacitance value of about 25 pF, for a total column parasitic capacitance of 2400 pF (96×25 pF). A typical value of current from current source 270 is 100 μA. Under these circumstances, the voltage will not rise faster than about 100 μA/(96×25 pF), or 1/24 V/μS, and will change even more slowly as the LED begins to conduct significantly. The result is that the current through the LED (as opposed to the current through the parasitic capacitance) will rise very slowly, and may not achieve the target current by the end of the scan period if starting from a low voltage. For example, if an exemplary display having 96 rows operates at 150 frames per second, then each scan has a duration of not more than 1/150/96 seconds, or less than about 70 μS. At a typical 100 μA drive current the voltage can charge at only about 42 mV per μS (when current begins to flow in the OLED, this charging rate will fall off). At 1/24 V/μS, the voltage would rise by no more than about 2.9 V during the scan period, which would not even bring a column voltage (Vcol) from 0 to a nominal conduction voltage of 6V.

Since the current source 270, alone, will be unable to bring an OLED from zero volts to operating voltage during the entire scan period in the circumstance described above, a distinct “precharge” period may be set aside during which the voltage on each device is driven to a precharge voltage value Vpr. Vpr is ideally the voltage which causes the OLED to achieve, at the beginning of its exposure period, the voltage which it would develop at equilibrium when conducting the selected current. The precharge is preferably provided at a relatively low impedance in order to minimize the time needed to achieve Vpr.

Each column has a connection switch 272 that connects the column to various sources at appropriate times. For example, during a precharge period, each of the switches 272 will connect the column to a precharge voltage source 288. The figure is shown during an exposure period, when a row switch such as 228 connects a row (K) to a drive voltage, and when each switch 272 connects each column (if active) to the corresponding current source 270. At the end of each column exposure period, the length of which may vary between columns, the corresponding column switch 272 may connect the column to a column discharge potential 290. The column discharge potential 290 may be ground, or another potential which is low enough to ensure rapid turn-off of the active elements.

It can be seen that at any instant in time, all of the column currents pass through a single row line, such as row line 252. Finite row resistance along the row line 252 creates a progressively larger voltage drop at progressively distant columns from the row switch. This voltage drop can cause irregularities in the current that is driven through the OLED as will be explained below. These current irregularities can cause undesirable variations in OLED luminosity across the display 280. In one embodiment, it is desirable to compensate for this voltage drop across the display 280 by driving the current sources 270 in the columns with larger voltage drops for longer periods of time than the current sources located in columns with smaller voltage drops to achieve the same pixel intensity.

The row line resistance can be determined with a fair degree of accuracy from the display manufacturing process. Using an estimate of the row line resistance and the precharge voltage Vpc, it can be determined how long to control the exposure for each column so that pixels have the same brightness to within an acceptable degree of tolerance.

Creating a Look-Up Table

In one embodiment, the duration the current source 270 is driven is obtained from a look-up table. This look-up table contains the ideal exposure times and correction times that are combined to produce compensating exposure times. Data for each column can be incorporated into the table, or alternately, the lookup table can be simplified by subdividing the row line 252 into regions where the row line voltage drop from one region to the adjacent regions will never be greater than a desired tolerance, for example less than 200 mV, less than 150 mV, or less than 100 mV, for any combination of exposures. It will be apparent to those skilled in the art that the actual value of voltage tolerance is unimportant, but it is desirable to determine tolerance level(s) suitable for each device. In most embodiments, this probably requires about six or fewer regions, though with a large number of columns, more regions can be required. If desired, no division of regions is necessary, and current exposure for individual pixels may be compensated on a pixel-by-pixel basis.

The look up table can be generated by measuring the pixel voltages of each column for the various combinations of row current caused by the various columns generating a current. Voltages can be measured using the process discussed above to determine Vcm. Alternately, the voltages of representative columns are sampled and the look-up table is generated using the row line resistance. As a practical matter, the exposure correction should be dynamic because the row line drop will depend on the length of all the exposures in every column driven by the row.

In an embodiment that divides the row line into regions, the same exposure correction is applied to every pixel in a region. The look up table is indexed by region, and by the exposure combinations. The index for the exposure of each region is determined by adding up the exposure combinations for each region. Table 1 illustrates example values of exposure corrections for an embodiment with 6 regions. One skilled in the art will understand that the values displayed in Table 1 are for demonstrative purposes and this table is not limited to the displayed values. This sum of the exposures corresponds to an average current drive for the region, which corresponds to a voltage drop across the row line resistance for that region. The total row line voltage drop seen by a given region of pixels is the sum of the voltage drops for all the regions between the row switch (e.g., 228) and the region itself. The regions that are located a greater distance from the row switch than the region of pixels being corrected need not be counted.

Compensation Values for Regions

| REGION | COMPESATION VALUE |
|---|---|
| 1 | 0.2 μsec |
| 2 | 0.4 μsec |
| 3 | 0.8 μsec |
| 4 | 1.6 μsec |
| 5 | 3.2 μsec |
| 6 | 6.4 μsec |

An embodiment of a method of generating the look-up table can be better appreciated after viewing the following examples. In one situation, where the desired exposure for columns 1 through (N−1) is zero, but column N is some non-zero exposure, there is no row line voltage drop error, and the exposure correction time is zero. In another situation, where some columns have short exposure and some columns have long exposure, randomly distributed over the length of the row, an exposure correction time should be determined. To determine the exposure correction time for column N, the exposures for the columns 1 through (N−1) would be added to estimate the average row line voltage drop.

The process for creating the look-up table can be explained using the following simplified example. The simplified display has four columns and a row line resistance of 1 k ohm between columns, for a total row line resistance of 4 k ohms. This example is for ease of discussion, most displays will have substantially more columns and lower row line resistance between columns. Column current is 100 μA, and the row scan time is 100 μsec. Assume the columns are precharged and that the precharge interval is negligibly small. Ideally, with no row line resistance and all columns on, the row line draws 4×100 μA=400 μA. At a first time T1, when all the columns are driving current, the voltage drop on the row line is (100 μA*1 k+100 μA*2 k+100 μA*3 k+100 μA*4 k)=1 volt. It can be seen that the voltage drop along the row line is non-linear.

At a second time T2, suppose columns 1, 2, 3 are not driving a current. Then the voltage drop seen by column 4 is 100 μA*4 k=400 mV. The voltage difference for any combination of exposures is bounded by these two cases.

In a further situation of the above example, four 25 μsec time intervals can be defined. In one case, column 1 has 100% exposure (i.e., 100 μsec on-time), column 2 has 50% exposure (i.e., 50 μsec on-time), column 3 has 25% exposure and column 4 has 75% exposure. The row line voltage drops seen by each column versus time are shown in Table 2.

Voltage Drop

| Column/Time Interval | 1 | 2 | 3 | 4 |
|---|---|---|---|---|
| 1 | 400 mV | 300 mV | 200 mV | 100 mV |
| 2 | 700 mV | 500 mV | 300 mV | 100 mV |
| 3 | 900 mV | 600 mV | 400 mV | 100 mV |
| 4 | 1000 mV | 700 mV | 500 mV | 100 mV |

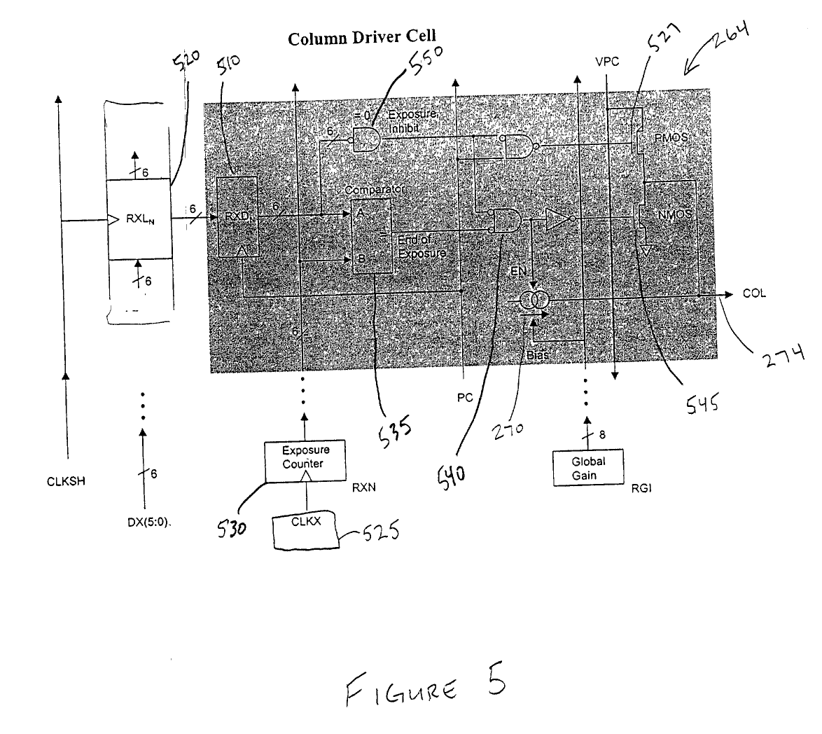

It is apparent that there are significant changes in voltage drops across the time intervals. FIG. 5 is a curve showing the current to voltage characteristics of a typical PLED of one manufacturer. The curve shows that the I-V characteristics of the PLEDs or OLEDs are non-linear. Referring to Table 2, the row line-drop on column 4 changes from an initial value of 1000 mV to only 100 mV. The effect is to transiently increase the current drive as the intermediate columns turn off. So, for instance, when column 3 turns off after 25 μsec, the drop at column 4 decreases by 300 mV. The capacitance on each column (equal to the number of rows multiplied by the pixel capacitance) is large enough to hold the column voltage up while the row voltage (as seen at the intersection with the column pixel) changes.

In this example, if the pixel of column 4, starts out with a voltage drop of 6 v in time interval 1, in time interval 2 the voltage drop will increase to 6.3 V, in time interval 3, the voltage drop will increase to 6.5 V, and the voltage drop will increase to 6.9 V in time interval 4. The I-V curve for a PLED from one manufacturer can be expressed as I=130 nA*(V−0.7 V)\hat{ }4.08, where V is the diode voltage and I is the diode current. Calculating the change in diode current caused by the sudden change in the row voltage between a PLED initial voltage of 6 V and a voltage of 6.3 V, the current changes by +25%.

One factor that must be considered in determining exposure time compensation is the assumption that the column capacitance sustains the column voltage. If the column is driven with a current source, this is only true for the initial transient. Over the remainder of the exposure time, the column voltage will start to droop, i.e., diminish or simply decrease. For example, with a 100 μA current drive and a column line capacitance of 2 nF (80 rows×25 pF per pixel, for example), the droop rate will be 50 volts per millisecond (100 μA/2 nF). In a 25 μsec time sub-interval (¼ of the total exposure period), the column could droop 1.25 V. The column voltage will drop until the transient decays enough to intersect the I-V operating point of the PLED. In this example, it will take about 6 usec for it to droop 300 mv.

The excess charge flowing through the PLED during the droop period represents the correctable exposure. If the total charge of the ideal exposure is Q=I*t, and the excess charge is the initial transient excess current ΔI times the droop time Δt, the excess charge ΔQ=½*ΔI*Δt. The ½ comes about because the current declines approximately linearly with a current drive. This is an approximation, but accurate enough for the needed results. Then the exposure correction (tcorr) equals −(ΔQ/Q)*t. Simplifying the above equations, we obtain Equation 1:

tcorr=−0.5*(ΔI/I)*Δt (Equation 1)

If I=100 μA, ΔI=25 μA (25% more), t=25 μsec, Δt=6 μsec, then the exposure correction is tcorr=0.75 μsec. This accounts only for the transition between one sub-interval to the next. The same procedure is followed for each transition. For instance, with 108 columns (a typical number) there could be 108 transitions.

Additionally, when creating the look up table, it is advantageous to account for the fact that when the sub-intervals (typically 1/16 to 1/64 of the total period available for exposure) get small, the transitions do not finish drooping, resulting in overlapping droops. Assuming the sub-intervals are small with respect to the droop simplifies the calculations dramatically while still providing acceptable results. The exposure correction is then directly proportional to the average row-line drop change. The changes in the row line drop correspond to current in the PLED, which can be determined from a table (voltage in, current out). Thus, knowing the PLED current versus time (but assumed constant across each exposure sub-interval) we can integrate to calculate the total charge that throws through the PLED during the entire exposure period, and compare this to the desired charge and determine the appropriate correction.

In summary, with the assumption that the changes in current do not droop during the subinterval, the current waveform in any OLED can be approximated by a staircase type of function. The total charge into the OLED is then the sum of the currents in each sub-interval multiplied by the length of a subinterval. The current in the subinterval is the nominal current with a correction corresponding to the row-line voltage drop, adjusted for the V-I characteristic of the OLED. The row-line drop is the sum of the exposure drive currents distributed across the row-line resistance. Averaging the exposure times results in a number that gives an effective average row-line voltage drop, which can in turn be non-linearly corrected via table lookup for a charge error for a given column. Then the charge error can be directly (linearly) related to an exposure timing compensation value. The compensation value can be added to or subtracted from the uncompensated exposure value so that the effective luminosity as seen by the eye is correct.

The conversion can take place in the microcontroller (not shown) and the conversion table can accept an uncompensated value as an argument and generate the compensated value via a look-up. Ideally, the process involves compensating for the exposure of the other pixels in the array. The microcontroller can use multiple table look-ups to accomplish this. Alternately, the microcontroller can calculate the value using multiple exposure values using equations.

The compensated value can be sent to the shift register (RXL) 520 as explained above. Alternately, the uncompensated values can be shifted in one register, and the compensation values can be shifted in a second register and combined within the column driver cell 264.

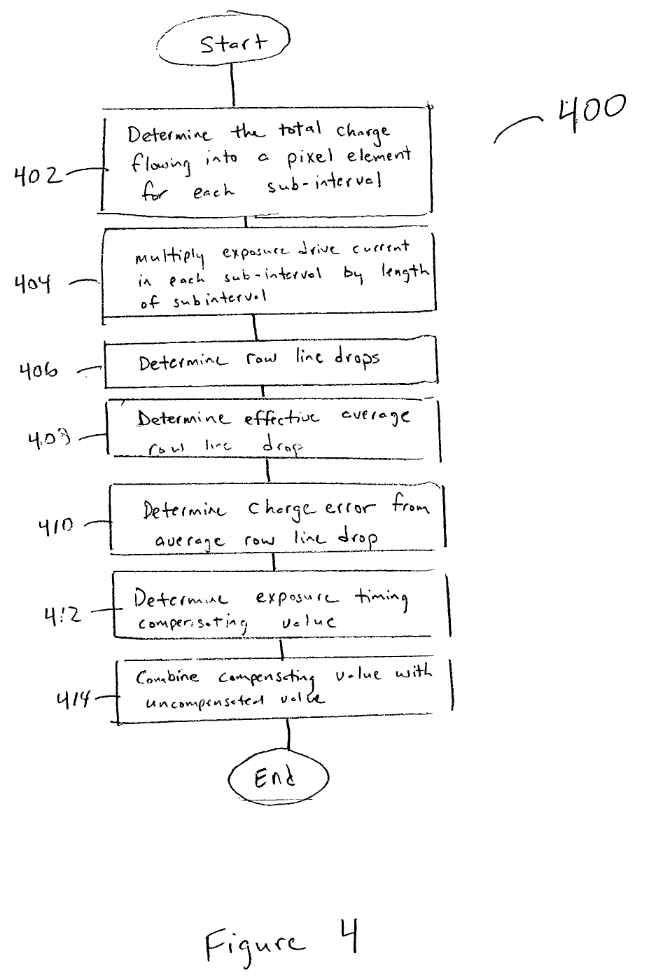

FIG. 4 illustrates a method 400 of creating a look-up table for compensating exposure data for a pixel element in a display as set forth above. In step 402, the total charge flowing into the pixel elements for each sub-interval is determined. In step 404, the sum of the exposure drive currents flowing into the pixel elements in each sub-interval is multiplied by the length of the subinterval. The current in the subinterval is the nominal current with a correction corresponding to the row-line voltage drop, adjusted for the V-I characteristic of the OLED. In step 406, the row-line drop is determined. The row-line drop is the sum of the exposure drive current multiplied by the row-line resistance. In step 408, the exposure times are averaged, resulting in a number that is proportional to an effective average row-line voltage drop. In step 410, the effective average row-line voltage drop is non-linearly corrected for a charge error for a given column. In step 412, the charge error is converted into an exposure timing compensating value. In step 414, the compensating value is added to or subtracted from the uncompensated exposure value to create the compensated exposure timing. Step 414 can be performed and stored in the look-up table or the combination of the compensation value and uncompensated value can be performed by a microcontroller.

Column Driver Operation

FIG. 5 illustrates the column drive circuit 264 for column J of the display 280 of FIG. 2. Column drive circuit 264 is typical of the column drive circuits for each of the columns in the display. The column drive circuit 264 includes an exposure data register (RXD) 410 that is loaded with exposure data at the beginning of a new row line. The exposure data sets the duration of time the column current source 270 will be active during the row cycle. As explained above, the amount of charge driven by the column current source 270 controls the luminosity of the pixel element 224 (see FIG. 2). Operating the column current source 270 for less than the entire row cycle reduces the average pixel luminosity for the corresponding pixel in the column 274 over what it would have been if held on for the entire row cycle, thereby achieving gray-scale intensity modulation.

In one embodiment in which there are 108 columns, the exposure data loaded into the exposure data register (RXD) 510 for each of the 108 columns is loaded from a 6 bit×108 stage shift register (RXL) 520 at the beginning of each row cycle. Exposure data is loaded serially into the shift register (RXL) 520 during the previous row cycle via an external microcontroller and a 6-bit data interface (not shown). At the beginning of each row cycle, each 6-bit wide stage of the exposure shift register (RXL) 520 transfers 6 bits of exposure data in the exposure data register (RXD) 510 within the corresponding column drive circuit (e.g. 262, 264, 268 of FIG. 2).

The exposure data in the exposure register (RXD) 510 of column drive circuit 264 represents the number of counts of an exposure clock CLKX 525 that the column current source 270 stays active. In one embodiment, the maximum number of counts the column current source 270 can stay active is 63. For any exposure data count from 1 to 63, the column 274 will be precharged to the voltage on pin Vpc with the PMOS switch 527, as explained above.

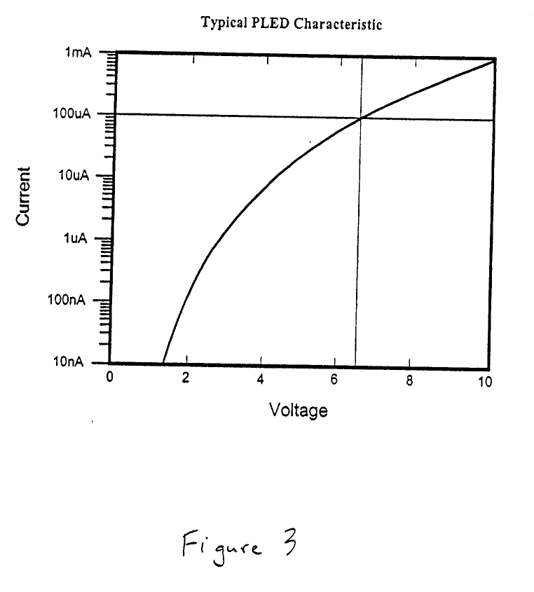

An exposure counter (RXN) 530 begins incrementing from zero following precharge at the beginning of the row cycle. It is desirable that the exposure counter 530 does not start counting until precharge is over because counting does not begin until the columns turn on and that binary values of the exposure words provide a linear estimate of the PWN pixel drive without offset. In one embodiment, all the column drive circuits (e.g., 262, 264, and 266 of FIG. 3) can share the exposure counter 530. Alternately, each column drive circuit can include a separate exposure counter.

A digital comparator 535 compares the word in the exposure counter (RXN) 530 with the word in the exposure data register (RXD) 510. Upon detecting a match, the digital comparator 535 generates a column disable signal, which is sent through a disable gate 540. The column disable signal turns off the column current source 270. The column disable signal also pulls the column 274 to ground via an NMOS pulldown switch 545. Operating the column current source 270 for less than the entire row cycle reduces the average pixel luminosity for the corresponding pixel in the column 274 over what it would have been if held on for the entire row cycle.

The column drive circuit 264 also includes a detection gate 550 to inhibit precharge if the exposure word in the exposure data register (RXD) 510 is zero. If the exposure data in the exposure data register 510 is zero, column precharge is inhibited by pulling the column 274 to ground rather than to VPC. This prevents transient luminescence during the time it takes to discharge a precharge pixel. If the detection gate 550 detects that the exposure word is zero, the detection gate 550 sends a signal to the disable gate 540, preventing the column current source 270 from biasing and driving a current and grounding the column 274 via the NMOS pulldown switch 545.

Thus, each individual pixel (i.e. 222, 224, 226 of FIG. 2) may generally be turned off at a different time during the scan of the pixels' row, permitting time-based control of the output of each pixel. The fractional activation time of the column current source 270 controls the pixel luminosity, i.e., the longer the exposure, the higher the intensity of the pixels in the display.

As explained above, exposure time is controlled by a value loaded into the shift register (RXL) 520 during the previous row cycle via an external microcontroller and a 6-bit interface. An exposure compensating time is added to the ideal exposure time to create an exposure time that compensates for the voltage drop and reduces the variations in pixel luminosity across the display. For example, columns (i.e., column 276) further from the row switch 228 can be compensated to receive longer exposures than columns (i.e., 278) closer to the row switch 228 to correct for luminosity variations across the columns of the display 280. A look-up table of precalculated values generated as described above can be used as the source of values to be loaded into the shift register (RXL) 520. Alternately, a digital signal processor can be used to generate the values to be loaded into the shift register (RXL) 520.

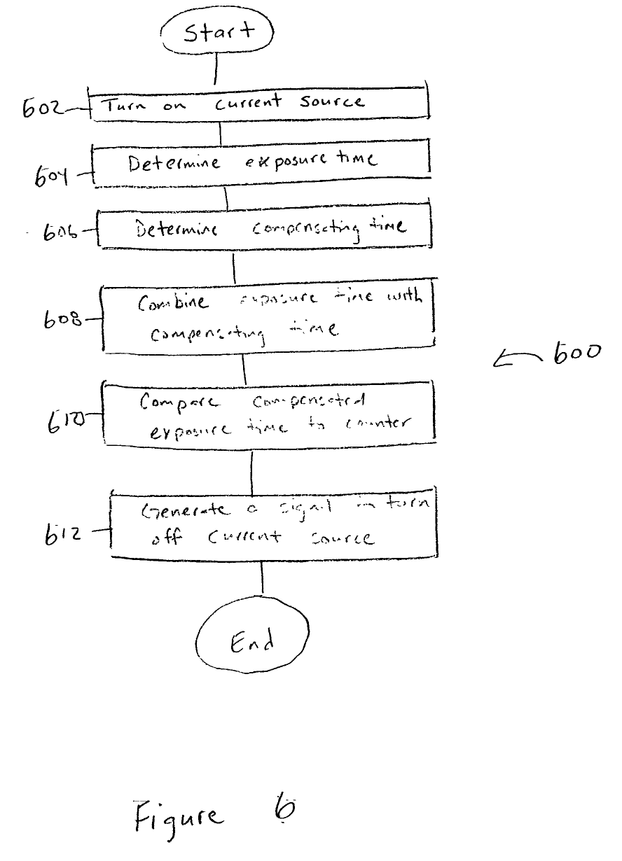

FIG. 6 illustrates a method 600 of controlling a current driven device by compensating for a voltage drop caused by row line resistance. In step 602, a current source is turned on to drive current through a pixel element in a display. In step 604, the activation time of the current source is determined for the desired luminosity of a pixel element in a display. In step 606, a compensating time is determined based on the change in luminosity of the pixel element caused by a voltage drop resulting from resistance in the row line. In step 608 the uncompensated exposure time and the compensating time are combined to obtain a compensated exposure time. In step 610, the compensated exposure time is compared to a counter until the exposure time and counter match. In step 612, a signal is generated to turn off the current source.

One skilled in the art will understand that there can be a similar exposure correction for the different rows in the display, reflecting the error in the precharge corresponding to the effect of column resistance. In this case, the same correction would be applied to all the columns in a row. Creating a lookup table to compensate for this error is based on the same principle, with essentially the same implementation.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A circuit configured to drive current through at least one light emitting element in a display, the circuit comprising:
at least one driver, wherein the driver is configured to drive current through the light emitting element; and
a processor configured to determine a period of time during which the driver is to drive current through the at least one light emitting element, wherein the processor is further configured to adjust the duration of the period of time based at least in part on compensating for luminosity variations in the display.

2. The circuit of claim 1, wherein the light emitting diode is organic.

3. The circuit of claim 1, wherein processor is configured to determine the period of time based upon a line resistance of at least a part of the circuit.

4. The circuit of claim 1, additionally comprising a table for storing the determined period of time.

5. A method of driving a current, comprising:
determining a voltage drop across at least a portion of a line in a circuit;
identifying an exposure period, wherein the exposure period compensates for the determined voltage drop; and
driving a current through a light emitting diode during the exposure period.

6. The method of claim 5, wherein the portion of a line in the circuit is located in a path between the light emitting diode and ground.

7. The method of claim 5, additionally comprising storing a value identifying the exposure period in a table.

8. The method of claim 5, wherein the light emitting diode is organic.

9. The method of claim 5, wherein identifying an exposure period comprises determining an effective average line drop voltage.

10. The method of claim 5, wherein driving a current though the light emitting diode comprises:
comparing a compensating time value with a counter value; and
generating a signal to turn off a current source when the compensating exposure time value matches the counter value.

11. The method of claim 5 wherein determining a voltage drop across at least a portion of a line in a circuit comprises measuring a resistance between two light emitting diodes in the circuit.

12. A system configured to drive a current, the system comprising:
means for determining a voltage drop across at least a portion of a line in a circuit;
means for identifying an exposure period, wherein the exposure period compensates for the determined voltage drop; and
means for driving a current through a light emitting diode for the exposure period.

13. The system of claim 12, wherein the portion of a line in the circuit is located in a path between the light emitting diode and ground.

14. The system of claim 12, additionally comprising means for storing a value identifying the exposure period in a table.

15. The system of claim 12, wherein the light emitting diode is organic.

16. The system of claim 12, wherein the means for identifying an exposure period comprises means for determining an effective average line drop voltage.

17. The system of claim 12, wherein the means for driving a current though the light emitting diode comprises:
means for comparing a compensating time value with a counter value; and
means for generating a signal to turn off a current source when the compensating exposure time value matches the counter value.

18. The system of claim 12, wherein the means for determining a voltage drop across at least a portion of a line in a circuit comprises means for measuring a resistance between two light emitting diodes in the circuit.
